(19) United States
(12) Patent Application Publication
(10) Pub. No.: US 2015/0234258 A1
(43) Pub. Date: Aug. 20, 2015

(54) SLIDER APPARATUS FOR FILMING

(71) Applicant: HEIWA SEIKI KOGYO CO., LTD., Saitama (JP)

(72) Inventor: Nobuyuki HIDA, Saitama (JP)

(21) Appl. No.: 14/327,069

(22) Filed: Jul. 9, 2014

(30) Foreign Application Priority Data
Feb. 20, 2014 (JP) 2014-030345

(51) Int. Cl. G03B 17/56

(52) U.S. Cl. CPC G03B 17/561

(57) ABSTRACT

A slider apparatus for filming includes: an elongate rail member having planar first traveling surfaces and planar second traveling surfaces inclined in relation to the first traveling surfaces; and a slider having first bearings movably and rotatably supported on the first traveling surfaces, second bearings movably and rotatably supported on the second traveling surfaces, and an initial setting mechanism for advancing and retracting the second bearings in relation to one of the second traveling surfaces to adjust contact pressure applied to the one of the second traveling surfaces by the second bearings.

### TECHNICAL FIELD

The invention relates to a slider apparatus for filming, for linearly sliding a filming apparatus thereon, such as a video camera.

### RELATED ART

Slider apparatuses for filming, so-called “camera sliders”, are known as filming equipment used when shooting by linearly, e.g., transversely, sliding a video camera. A typical example of such slider apparatus for filming is the one described in JP 2005-24442 A. The stereoscopic-image capturing device described in JP 2005-24442 A includes one ITV camera, a memory unit, an elevation angle adjusting stage, an azimuth adjusting stage, a slider, a pedestal, a level, and a power supply. Among these components, the slider, pedestal, and level constitute a slider apparatus for filming. When shooting, the pedestal is horizontally fixed onto a mount on a tripod, with the assistance of the level, the video camera is fixed to the slider, and the slider is directed at a subject and moved transversely for shooting.

Owing to the sliding movement of the slider on the pedestal, such slider apparatus for filming can follow a moving subject along its moving direction for shooting with a video camera, and shoot with the video camera while changing the target subject; thus, a variety of expression of the resulting captured images is embodied. Further advantage with the apparatus is that vibration-free and stable images are available.

There is a demand for this type of slider apparatuses for filming to provide increased stability in linear sliding movement and increased ease with which such sliding movement is adjusted.

### SUMMARY

The present invention has been made in view of the situation described above with an objective to provide a slider apparatus for filming, enabling increased stability in linear sliding movement and increased ease with which such sliding movement is adjusted.

In order to solve the above problems, a slider apparatus for filming of the invention includes: an elongate rail member having planar first traveling surfaces and planar second traveling surfaces that are inclined in relation to the first traveling surfaces; and a slider having first bearings that are movably and rotatably supported on the first traveling surfaces, second bearings that are movably and rotatably supported on the second traveling surfaces, and an initial setting mechanism for advancing and retracting the second bearings in relation to the second traveling surface to adjust contact pressure applied to the second traveling surface by the second bearings; wherein the slider has a pair of support surfaces disposed opposite to each other and rotatably supporting the first bearings therebetween, and skirts extending obliquely from the respective opposing support surfaces in a direction opposite to the support surfaces, having the second bearings rotatably attached thereto, the initial setting mechanism has an adjusting bolt, fixing bolts, a fixing section having a topside onto which an underside of the skirt can be placed and having screw sections into which the fixing bolts can be screwed, and a contact pressure adjusting section for the second bearings, disposed in the fixing section, and into which the adjusting bolt can be screwed, and the initial setting mechanism is incorporated into one of the skirts, screw-fitting of the adjusting bolt with the contact pressure adjusting section changes a position of the skirt in relation to the fixing section, the second bearings are advanced or retracted in relation to the second traveling surface; the contact pressure applied to the second traveling surface by the second bearings is changed such that the skirt is fixed to the fixing section by screw-fitting of the fixing bolts with the screw sections and the second bearings are enabled to travel on the second traveling surface with the adjusted contact pressure.

In accordance with the slider apparatus for filming of the invention, linear sliding movement of a slider is more stabilized; furthermore, adjustment of the sliding movement of the slider becomes easier.

### BRIEF DESCRIPTION OF DRAWINGS

FIG. 1 is a perspective view showing one embodiment of a slider apparatus for filming according to the invention;

FIG. 2 is a cross-sectional view of an essential part, showing a main body of a rail member of the slider apparatus for filming shown in FIG. 1;

FIG. 3 is a side view showing a slider of the slider apparatus for filming shown in FIG. 1;

FIGS. 4A, 4B, and 4C are cross-sectional views of the slider shown in FIG. 3, viewed along arrows A-A, B-B, and C-C, respectively;

FIG. 5 is an exploded perspective view of the slider shown in FIG. 3, seen from the side of one support surface;

FIG. 6 is an exploded perspective view of the slider shown in FIG. 3, seen from the side of the other support surface;

FIG. 7 is a perspective view showing a tripod assembly made by attaching the slider apparatus for filming shown in FIG. 1 to a tripod;

FIG. 8 is a perspective view showing a tightening handle for attaching the slider apparatus for filming shown in FIG. 1 to a tripod;

FIG. 9 is an exploded cross-sectional view of an essential part, showing how to attach the slider apparatus for filming shown in FIG. 1 to a tripod; and

FIG. 10 is a perspective view showing a tripod assembly made by attaching the slider apparatus for filming shown in FIG. 1 to a tripod, and further attaching a pan head to the slider apparatus for filming.

### DETAILED DESCRIPTION

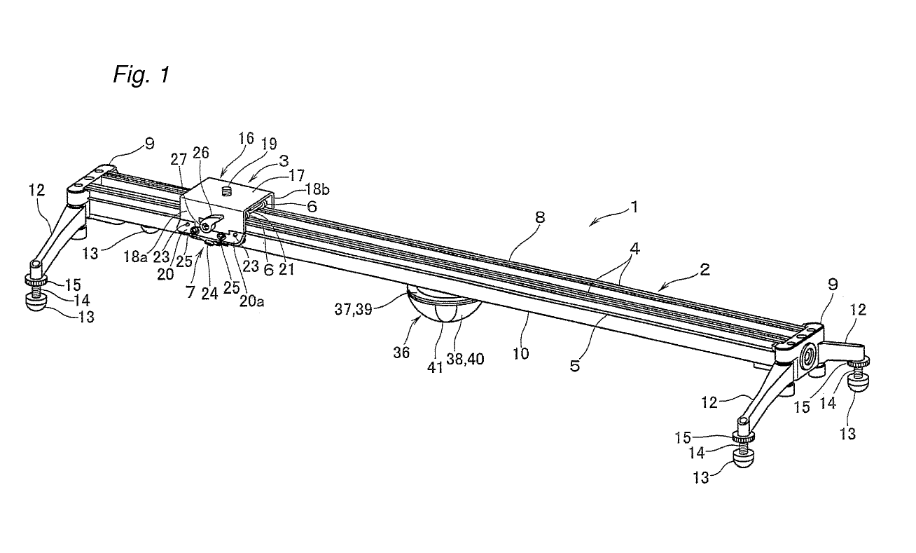

FIG. 1 is a perspective view showing one embodiment of a slider apparatus for filming according to the invention.

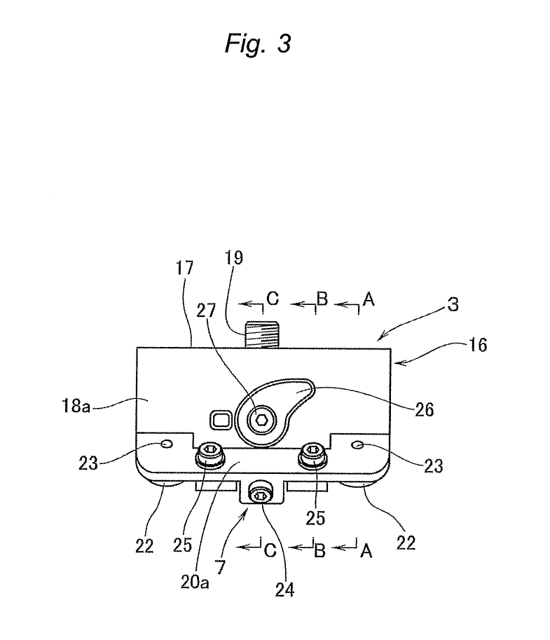

A slider apparatus 1 for filming includes an elongate rail member 2 and a slider 3. The rail member 2 has planar first traveling surfaces 4 and planer second traveling surfaces 5 that are inclined in relation to the first traveling surfaces 4. The slider 3 has first bearings 6 that are movably and rotatably supported on the first traveling surfaces 4, and second bearings (shown in FIG. 3) that are movably and rotatably supported on the second traveling surfaces 5. Further, the slider 3 has an initial setting mechanism 7 for advancing and retracting the second bearings in relation to the second traveling surface 5 to adjust contact pressure applied to the second traveling surface 5 by the second bearings.

More specifically, the rail member 2 includes a main body 8 having the first traveling surfaces 4 and the second traveling surfaces 5, and bases 9 attached to the respective longitudinal ends of the main body 8.

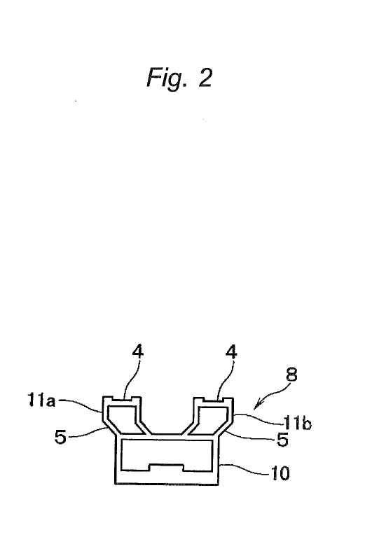

FIG. 2 is a cross-sectional view of an essential part, showing the main body of the rail member of the slider apparatus for filming shown in FIG. 1.

The main body 8 is made up of a frame 10 that is hollow and has a rectangular cross section, and rails 11a, 11b that are obliquely and outwardly raised from cross-directional opposite ends of the frame 10, respectively, and then extend upright from the raised top ends. The rails 11a, 11b are hollow as well as the frame 10, and are disposed symmetrically with respect to the center of the frame 10 in a cross direction. The first traveling surfaces 4 are formed in the top face of each of the rails 11a, 11b, dented with a concave shape. The first traveling surfaces 4 formed in the top face of each of the rails 11a, 11b are flush with each other. The second traveling surfaces 5 are outer surfaces of portions of the rails 11a, 11b, which portions are obliquely raised from the frame 10. The second traveling surfaces 5 are inclined in relation to the first traveling surfaces 4 at an angle of 45°. This inclination angle of the second traveling surfaces 5 in relation to the first traveling surfaces 4 is not limited to 45°, but it may be any acute angle greater than 0° and less than 90° as long as the slidability of the slider 3 along the rail member 2, as shown in FIG. 1, is stabilized.

As shown in FIG. 1, each of the bases 9 has two legs 12 extending down therefrom obliquely and outwardly in a cross direction of the main body 8. The degree of spreading of the two legs 12 is adjustable. At each distal end of the legs 12, an adjuster 13 is provided for adjustment for level installation of the slider apparatus 1 for filming; the adjuster 13 has a bolt 14; the bolt 14 is withdrawable at the distal end of the leg 12. At the distal end of the leg 12, a lock nut 15 is provided. The bolt 14 of the adjuster 13 is rotatable with respect to the lock nut 15, and rotation of adjuster 13 can vary a protruded length of the bolt 14 from the distal end of the leg 12. Tightening of the lock nut 15 will disable the rotation of the adjuster 13. Loosening of the lock nut 15 will enable the rotation of the adjuster 13.

The slider 3 includes a main body 16. The main body 16 is made up of a planar attachment surface 17 on which a video camera or pan head is mounted and a pair of support surfaces 18a, 18b extending from cross-directional opposing edges of the attachment surface 17, respectively. The support surfaces 18a, 18b are disposed opposite to each other. In the middle of the attachment surface 17, a male thread 19 is projected to be screwed into a female thread formed for attachment in the bottom surface of the video camera or pan head. On edges of the support surfaces 18a, 18b, skirts 20a, 20b are provided, respectively, extending in an opposite direction from the opposing support surfaces 18a, 18b, that is, obliquely and externally in a cross direction of the main body 16. The initial setting mechanism 7 is incorporated into the skirt 20a of the support surface 18a.

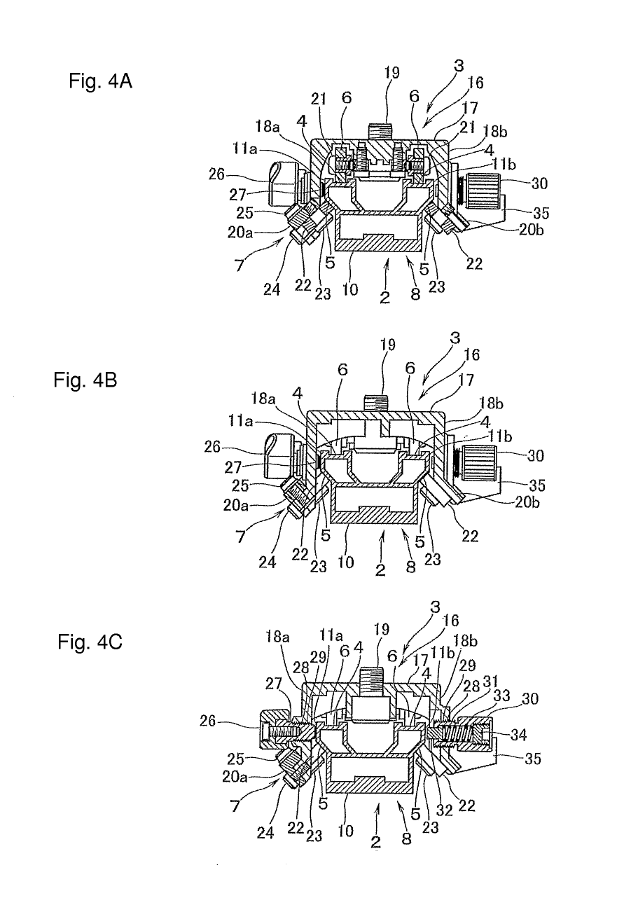

FIG. 3 is a side view showing a slider of the slider apparatus for filming shown in FIG. 1. FIGS. 4A, 4B, and 4C are cross-sectional views of the slider shown in FIG. 3, viewed along arrows A-A, B-B, and C-C, respectively.

The first bearings 6 extend from the attachment surface 17 between the support surfaces 18a, 18b, rotatably attached to ribs disposed parallel to the support surfaces 18a, 18b by means of shafts 21, and thus supported between the support surfaces 18a, 18b. Two first bearings 6 are positioned at each of the longitudinal ends of the main body 16. Thus, the slider 3 includes a total of four first bearings 6. The first bearings 6 are placed on the first traveling surfaces 4 of the rail member 2, enabled to travel on the first traveling surfaces 4.

The second bearings 22 are rotatably attached to the skirts 20a, 20b of the support surfaces 18a, 18b by means of shafts 23, where the second bearings 22 are disposed inside the main body 16. As is the case with the first bearings 6, two second bearings 22 are positioned at each of the longitudinal ends of the main body 16; thus, the slider 3 includes a total of four second bearings 22.

The initial setting mechanism 7 is incorporated into the skirt 20a of the slider 3. The initial setting mechanism 7 includes an adjusting bolt 24 and fixing bolts 25. By screwing in the adjusting bolt 24, the second bearings 22 can come in contact with the second traveling surface 5, thereby elevating the contact pressure. In contrast, by loosening the adjusting bolt 24, the contact pressure applied to the second traveling surface 5 by the second bearings 22 can be lowered. The contact pressure applied to the second traveling surface 5 by the second bearings 22 will be adjusted so as to enable the second bearings 22 to travel on the second traveling surface 5 smoothly. Once the contact pressure applied to the second traveling surface 5 by the second bearings 22 is adjusted, the fixing bolts 25 are screwed in. The fixing bolts 25 will maintain a state in which the contact pressure suitable for sliding has been adjusted. The adjusting bolt 24 is disposed parallel to a cross direction of the skirt 20a, in the center of a longitudinal direction of the skirt 20a. The fixing bolts 25 are spaced away from each other by a distance in the longitudinal direction of the skirt 20a with the adjusting bolt 24 in the middle. Hence, a total of two fixing bolts 25 are provided for the initial setting mechanism 7.

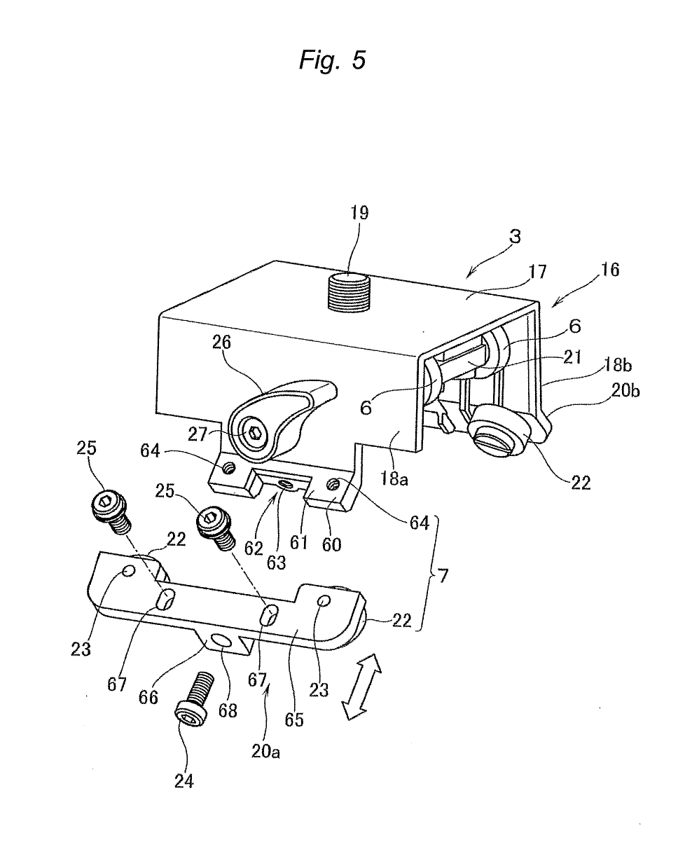

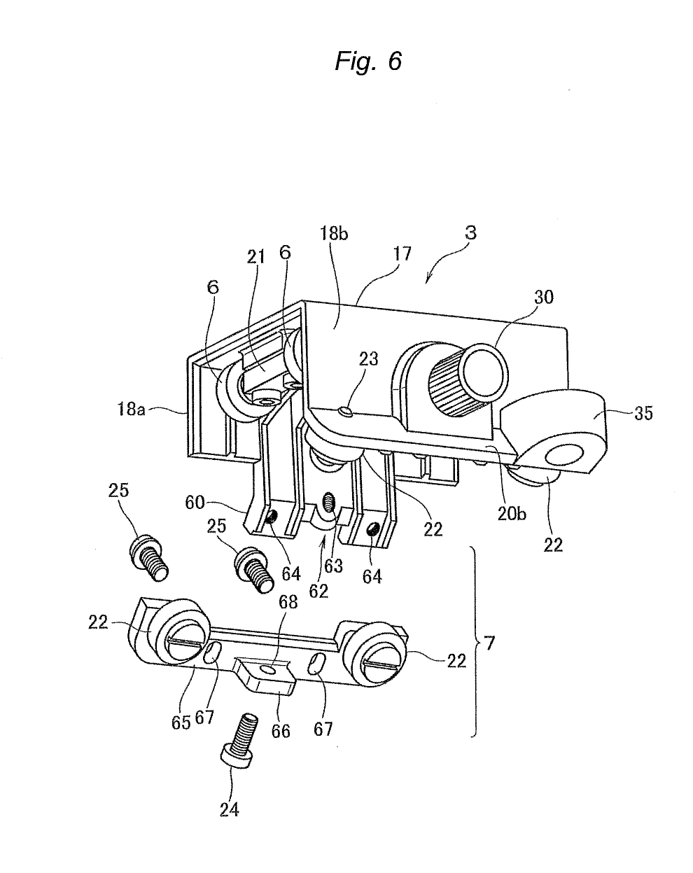

FIG. 5 is an exploded perspective view of the slider shown in FIG. 3, seen from the side of one support surface. FIG. 6 is an exploded perspective view of the slider shown in FIG. 3, seen from the side of the other support surface.

As described above, the initial setting mechanism 7 is incorporated into the skirt 20a of the slider 3. The skirt 20a has a fixing section 60 in a longitudinal central section of the support surface 18a, extending in an opposite direction from the attachment surface 17 and bent so as to be oblique to the attachment surface 17. The surface of the fixing section 60 is a plane 61. The fixing section 60 is provided with a notch 62 in a longitudinal central section thereof, and the notch 62 is provided with a female thread-like contact pressure adjusting section 63. The contact pressure adjusting section 63 is for the adjusting bolt 24 to adjust the contact pressure applied by second bearings 22. Further, in the fixing section 60, female thread-like screw sections 64 are provided across the notch 62 along a longitudinal direction of the fixing section 60.

The skirt 20a further has a main body 65, to which the second bearings 22 will be attached, and a projection 66, which is projecting from a central section of the main body 65 at a side where the second bearings 22 will be attached. The main body 65 has enlarged width at its respective longitudinal ends where the second bearings 22 are rotatably attached, respectively, by means of the shafts 23. The main body 65 is also provided with two oblong holes 66 elongated in a cross direction of the main body 65 and disposed inward from where the second bearings 22 are attached. These oblong holes 66 can be aligned with the respective screw sections 64 in the fixing section 60. The width of the projection 66, or its length in a longitudinal direction of the main body 65, is within the length of the notch 62 of the fixing section 60. The projection 66 is provided with a bolt insert hole 68 inwardly therethrough, which can be aligned with the contact pressure adjusting section 63 of the fixing section 60.

The skirt 20a is positioned with its planar underside on top of topside of the main body 65 so that each of the two second bearings 22 is located outwardly in relation to the fixing section 60 in a longitudinal direction. Here, the two oblong holes 67 in the main body 65 are aligned with the two screw sections 64 of the fixing section 60, respectively; the projection 66 is positioned within the notch 62 of the fixing section 60; and the bolt insert hole 68 is aligned with the contact pressure adjusting section 63. In this state, the adjusting bolt 24 is inserted from the outside of the projection 66, screwed through the bolt insert hole 68, into the contact pressure adjusting section 63. By varying an extent to which the adjusting bolt 24 is screwed, that is, by tightening and loosening the adjusting bolt 24, the main body 65 of the skirt 20a is moved relative to the fixing section 60 in a direction shown in an arrow in FIG. 5. As a result, the position of the skirt 20a relative to the fixing section 60 is changed, the second bearings 22 are advanced or retracted in relation to the second traveling surface 5, and thus the contact pressure applied to the second traveling surface 5 by the second bearings 22 can be adjusted, as shown in FIG. 4C. Once the contact pressure is adjusted, as shown in FIGS. 4A and 4B, the two fixing bolts 25 are inserted at the two oblong holes 67, respectively, in the skirt 20a from the outside thereof, then screwed into the screw sections 64. By screwing the fixing bolts 25 into the screw sections 64, the main body 65 of the skirt 20a is fixed to the fixing section 60, and thus, a state in which a suitable contact pressure for traveling of the second bearings 22 has been adjusted will be maintained. Hence, the second bearings 22 are enabled to travel on the second traveling surface 5 with the adjusted contact pressure.

Further, the slider 3 is provided with a brake knob 26, turnably disposed in a longitudinal central section of the support surface 18a. As shown in FIG. 4C, the brake knob 26 has a brake shaft 27 having a male thread 28 being cut thereon. The support surface 18a is tapped with a female thread 29 inwardly therethrough, allowing the brake shaft 27 to advance and retract therein, so that the male thread 28 of the brake shaft 27 is screwed into the female thread 29. By rotating the brake knob 26 so that a tip portion of the brake shaft 27 comes in contact with a longitudinal outer face of the rail 11a of the rail member 2, applying pressure thereto, the slider 3 is disabled to slide along the rail member 2. In contrast, by rotating the brake knob 26 in a reverse direction to remove the pressure applied by the brake shaft 27, the slider 3 is enabled to slide.

A friction knob 30 is rotatably provided in a longitudinal central section of the support surface 18b opposite to the support surface 18a, as shown in FIG. 4C. The friction knob 30 has a first friction shaft 31 having a male thread 28 being cut thereon. The support surfaces 18b is tapped with a female thread 29 inwardly therethrough, allowing the first friction shaft 31 to advance and retract therein, so that the male thread 28 of the first friction shaft 31 is screwed into the female thread 29. A second friction shaft 32 is provided at a tip portion of the first friction shaft 31, allowed to advance and retract in a longitudinal direction of the first friction shaft 31. Except for its tip portion, the second friction shaft 32 is accommodated in a hollow section 33 formed in the first friction shaft 31. The hollow section 33 is formed from the tip portion of the second friction shaft 32 to the friction knob 30. A coil spring 34 is embedded in the hollow section 33 in an expandable manner between the friction knob 30 and the second friction shaft 32.

When the friction knob 30 is rotated so as to screw in the first friction shaft 31 toward the rail 11b of the rail member 2, the tip portion of the second friction shaft 32 comes in contact with a longitudinal outer face of the rail 11b. Here, the coil spring 34 embedded in the hollow section 33 contracts, generating an elastic force. The generated elastic force applies pressure onto the outer face of the rail 11b via the tip portion of the second friction shaft 32, generating friction. The magnitude of the friction is adjustable by an extent to which the first friction shaft 31 is screwed in as a result of rotation of the friction knob 30. For example, the friction can be reduced to make the slider 3 slide fast, whereas it can be increased to make the slider 3 slide slow. The generated friction also assists effectively the adjusting bolt 24 in the initial setting mechanism 7 when adjusting contact pressure to be applied to the second traveling surface 5 by the second bearings 22, facilitating the adjustment of the contact pressure.

The support surface 18b is further provided with a level 35 adjacent to the friction knob 30. The level 35 is projected outwardly from the support surface 18b.

To install such slider apparatus 1 for filming on a mount, the rail member 2 is disposed such that the two legs of the respective bases 9 at the respective longitudinal ends of the rail member 2 are spread at an appropriate angle, and the adjusters 13 at the respective distal ends of the legs 12 are abutted against the mount surface. Here, the slider 3 has been disabled to slide by rotating the brake knob 26 with the first bearings 6 placed on the first traveling surfaces 4 in the presence of a certain amount of friction generated by rotating the friction knob 30. Next, with the assistance of the level 35, the adjusters 13 are rotated to change their lengths until the rail member 2 is disposed horizontally, and then fixed by the lock nut 15 to complete the installation of the rail member 2.

Following this, the brake knob 26 is rotated reversely to free the slider 3, and then, by means of the adjusting bolt 24 in the initial setting mechanism 7, the second bearings 22 are moved toward the second traveling surface 5 to come in contact therewith, and the contact pressure is adjusted. After the sliding movement of the slider 3 along the rail member 2 is checked, the fixing bolts 25 in the initial setting mechanism 7 is screwed in so as to maintain the adjusted contact pressure. The foregoing adjustment of the contact pressure from the contact between the second bearings 22 and the second traveling surface 5 and maintenance thereof may be performed either before or after attaching a video camera or pan head to the attachment surface 17.

As described above, the slider apparatus 1 for filming has: the rail member 2 having the first traveling surfaces 4 and second traveling surfaces 5 inclined in relation to the first traveling surfaces 4; and the slider 3 having the first bearings 6 movable on the first traveling surfaces 4 and second bearings 22 movable on the second traveling surfaces 5. Owing to this configuration, the linear sliding movement of the slider 3 along the rail member 2 is more stabilized. The stability of the linear sliding movement is embodied by providing a total of four first bearings 6 and a total of four second bearings 22. Further, in the slider apparatus 1 for filming, the slider 3 has the initial setting mechanism 7 for advancing and retracting the second bearings 22 in relation to the second traveling surface 5 to adjust the contact pressure applied to the second traveling surface 5 by the second bearings 22; this configuration facilitates adjusting the sliding movement of the slider.

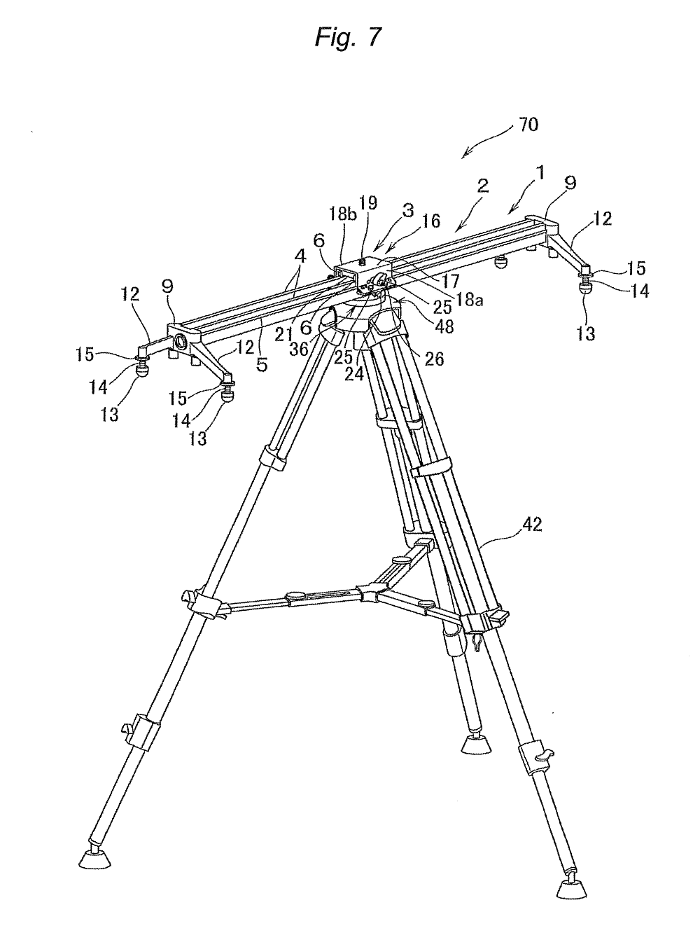

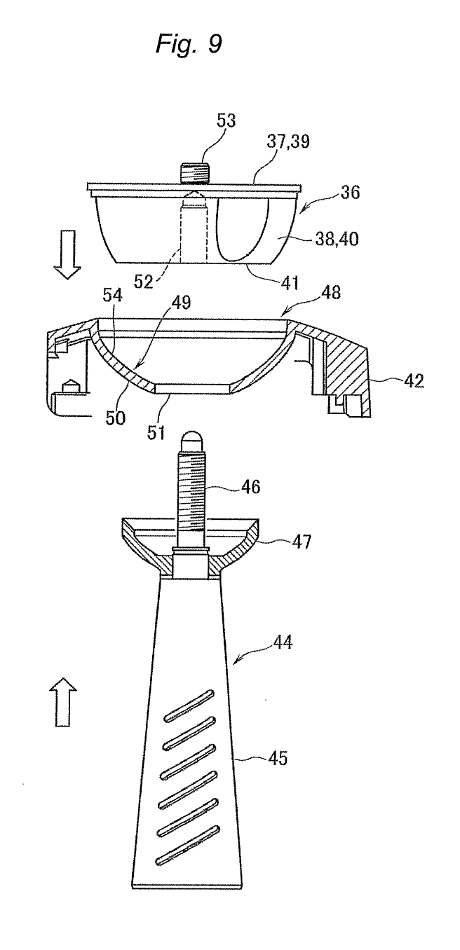

The slider apparatus 1 for filming is further provided with an adapter 36 in the middle of the frame 10 of the rail member 2, as is shown in FIG. 1, for attachment to a tripod (shown by reference 42 in FIG. 7). The adapter 36 has a first contact surface 37 that can contact the frame 10 of the rail member 2 and a second contact surface 38 that can contact an attachment section (shown by reference 49 in FIG. 9) provided at a top section of the tripod (shown by reference 48 in FIG. 7). The first contact surface 37 is a plane 39, and the second contact surface 38 has a curved surface 40. The second contact surface 38 also has a plane 41 in a section disposed opposite to the first contact surface 37. In the second contact surface 38, in the middle of a side for attaching to the tripod, a female thread for attaching (shown by reference 52 in FIG. 9) is embedded. The adapter 36, as is shown in FIG. 1, is a relatively thin member in size with a maximum thickness being the height of the legs 12. Furthermore, the adapter 36 does not include any members that would protrude from the second contact surface 38; therefore, it does not cause any problem when installing the slider apparatus 1 for filming on the mount.

It should be noted that the slider apparatus 1 for filming has been tapped with a total of three female threads (not shown) for attaching the adapter 36: one in the middle of the frame 10 of the rail member 2 and the other two at longitudinal ends thereof, respectively. In the middle of the first contact surface 37 of the adapter 36, an upright male thread is disposed (shown by reference 53 in FIG. 9). Screw-fitting of this male thread and one of the female threads allows detachable attachment of the adapter 36 to the rail member 2, and the attachment position of the adapter 36 in relation to the rail member 2 can be changed by selecting one of the female threads made in the frame 10.

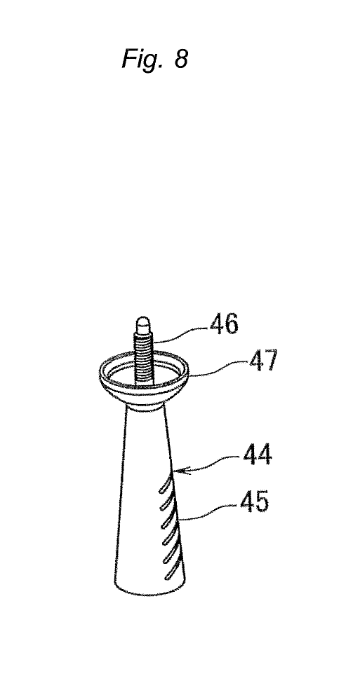

FIG. 7 is a perspective view showing a tripod assembly made by attaching the slider apparatus for filming shown in FIG. 1 to a tripod. FIG. 8 is a perspective view showing a tightening handle for attaching the slider apparatus for filming shown in FIG. 1 to a tripod. FIG. 9 is an exploded cross-sectional view of an essential part, showing how to attach the slider apparatus for filming shown in FIG. 1 to a tripod.

As shown in FIG. 7, the slider apparatus 1 for filming can be attached to a tripod 42 to make a tripod assembly 70, in which the slider apparatus 1 for filming is attached to the tripod 42. As shown in FIG. 9, the adapter 36 is placed in an attachment section 49 provided in a top section 48 of the tripod 42, and a tightening handle 44 is tightened against the adapter 36 from the outside of the attachment section 49 so that the adapter 36 comes into pressure-contact with the attachment section 49 to thereby attaching and securing the slider apparatus 1 for filming to the tripod 42.

More specifically, the tightening handle 44 is provided with a male thread 46 protruding from one end of a grip 45, and a curved saucer-like support 47 in the periphery of the section where the male thread 46 protrudes from the grip 45, which support 47 can contact an outer curved surface 50 of the bowl-like concave attachment section 49 in the top section 48 of the tripod 42. In the attachment section 49 of the top section 48 of the tripod 42, an opening 51 is formed therethrough in a longitudinal direction of the tripod 42. When forming the tripod assembly 70, the curved surface 40 of the second contact surface 38 of the adapter 36 is placed on an inner curved surface 54 of the attachment section 49 of the top section 48 of the tripod 42. Following this, from the outside of the curved surface 50 of the attachment section 49 of the top section 48 of the tripod 42, male thread 46 of the tightening handle 44 is screwed into a female thread 52 embedded in the adapter 36 via the opening 51 made in the attachment section 49, and tightened. As the tightening handle 44 tightens, the curved surface 40 of the second contact surface 38 of the adapter 36 and the outer curved surface 50 of the attachment section 49 of the top section 48 of the tripod 42 come into surface and pressure contact with each other. Due to this pressure contact, the adapter 36 is secured to the attachment section 49 of the top section 48 of the tripod 42, and thus the slider apparatus 1 for filming is fixed to the tripod 42 to make the tripod assembly 70. Hence, the tripod assembly 70 is made with ease because the slider apparatus 1 for filming can be easily attached to the tripod 42. Further, the contact made by the support 47 of the tightening handle 44 with the curved surface 50 of the attachment section 49 of the top section 48 of the tripod 42 steadily maintains the fixed state of the slider apparatus 1 for filming and the tripod 42.

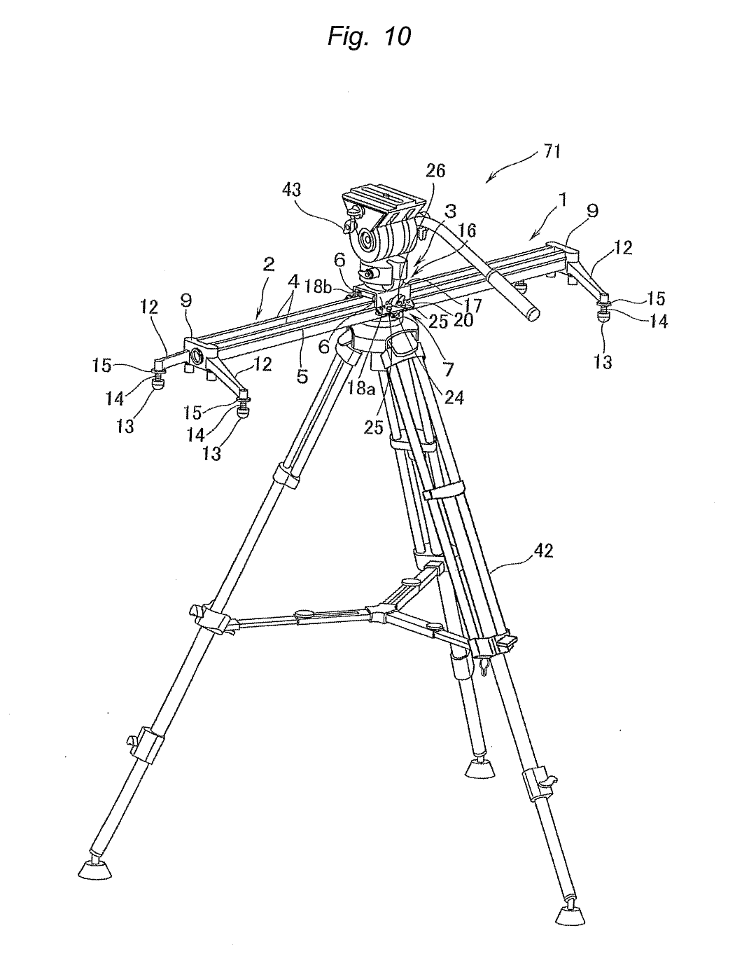

FIG. 10 is a perspective view showing a tripod assembly made by attaching the slider apparatus for filming shown in FIG. 1 to a tripod, and further attaching a pan head to the slider apparatus for filming.

In a tripod assembly 71, the slider apparatus 1 for filming in the tripod assembly 70 shown in FIG. 7 is attached with a pan head 43. The pan head 43 is provided with a female thread (not shown) in its bottom for screw-fitting with the male thread 19 provided in the attachment surface 17 of the main body 16 of the slider 3. By the screw-fitting of the female thread and the male thread 19, the pan head 43 is attached and secured to the slider 3. Now that the pan head 43 is provided for the tripod assembly 71, panning and tilting as well as sliding of a video camera are possible; thus, capturing moving targets and shooting in different styles suitable for a desired image are enabled.

It should be noted that the tightening handle 44 shown in FIG. 8 can be used commonly with one used for attaching the pan head 43 directly to the tripod 42 without attaching the slider apparatus 1 for filming.

Also, in the tripod assemblies 70 and 71, because the second contact surface 38 of the adapter 36 in the slider apparatus 1 for filming has the curved surface 40, the slider apparatus 1 for filming can be positioned not only horizontally but also in a tilted manner in a desired direction.

The slider apparatus for filming of the present invention is not limited to the above embodiment. However, a variety of modes for the shapes and structures of the rail member and slider are possible.

1. A slider apparatus for filming, comprising:
an elongate rail member having planar first traveling surfaces and planar second traveling surfaces inclined in relation to the first traveling surfaces; and
a slider having first bearings movably and rotatably supported on the first traveling surfaces, second bearings movably and rotatably supported on the second traveling surfaces, and an initial setting mechanism for advancing and retracting the second bearings in relation to one of the second traveling surfaces to adjust contact pressure applied to one of the second traveling surfaces by the second bearings, wherein:
the slider has a pair of support surfaces disposed opposite to each other and rotatably supporting the first bearings therebetween, and skirts extending obliquely from the respective opposing support surfaces in a direction opposite to the support surfaces, and having the second bearings rotatably attached thereto,
the initial setting mechanism includes an adjusting bolt, fixing bolts, a fixing section having a topside onto which an underside of one of the skirts can be placed and having screw sections into which the fixing bolts can be screwed, and a contact pressure adjusting section for the second bearings, disposed in the fixing section, and into which the adjusting bolt can be screwed,
the initial setting mechanism is incorporated into the one of the skirts,
the one of the skirts into which the initial setting mechanism is incorporated is separately provided from the fixing section and a position of the one of the skirts is changeable in relation to the fixing section upon movement of the one of the skirts along the fixing section,
in a state in which the adjusting bolt is screwed with the contact pressure adjusting section, the position of the one of the skirts is changed in relation to the fixing section, the second bearings are advanced or retracted in relation to the one of the second traveling surfaces, and a contact pressure applied to the one of the second traveling surfaces by the second bearings is changed, and
in a state in which the one of the skirts is fixed to the fixing section by screw-fitting of the fixing bolts with the screw sections, the second bearings are enabled to travel on the one of the second traveling surfaces with an adjusted contact pressure.

2. The slider apparatus for filming according to claim 1, wherein the rail member is provided with an adapter for attaching to a tripod, a first contact surface of the adapter is in contact with the rail member and is planar, a second contact surface is in contact with the tripod and has a curved surface, and a female thread for attachment is embedded in the second contact surface in a middle of a side for attaching the tripod.

3. The slider apparatus for filming according to claim 1, wherein the pair of support surfaces are parallel to one another.

4. The slider apparatus for filming according to claim 1, wherein the first bearings are perpendicular to the rail member.

5. The slider apparatus for filming according to claim 1, wherein the rail member comprises a frame that has a rectangular cross section, and rails that are obliquely and outwardly raised from opposite ends of the frame, respectively.
